(19) United States
(12) Patent Application Publication
(10) Pub. No.: US 2008/0254290 A1
(43) Pub. Date: Oct. 16, 2008

(54) Sizing Composition for Glass Fibre Granules with a High Glass Content

(75) Inventors: Jean-Philippe Gasca, Saint-Jean De La Porta (FR); Yohann Barnaud, Chambery (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN VETROTEX FRANCE S.A., Chambery (FR)

(21) Appl. No.: 11/913,109

(22) PCT Filed: May 2, 2006
(86) PCT No.: PCT/FR2006/050405

§ 371 Date: May 28, 2008

(30) Foreign Application Priority Data
May 4, 2005 (FR) 0551178

(51) Int. Cl. B32B 17/02; B29C 45/00; C08L 51/00

(52) U.S. Cl. 428/378; 428/375; 264/299; 525/80

(57) ABSTRACT

The invention relates to a glass-strand sizing composition comprising the following constituents, in the following contents by weight expressed as percentages of the solids:
10 to 99% of at least one copolymer chosen from ethylene/vinyl acetate or ethylene/(meth)acrylic acid copolymers;
1 to 40% of at least one coupling agent; and
0 to 90% of polypropylene grafted by at least one unit derived from at least one monomer containing one or more functional groups that can react with the coupling agent.

The glass strands obtained are intended for producing glass-strand granules with a high glass content for the production of composite parts having a thermoplastic matrix reinforced by chopped glass strands using the injection-moulding technique.

The invention relates to a sizing composition for glass strands that can be used to form granules with a high glass content. These granules are intended more particularly for manufacturing moulded parts made of a thermoplastic reinforced by glass strands, this being known as an RPT (the abbreviation for “reinforced thermoplastic”).

Such parts may be manufactured in various ways, especially by the technique of “injection moulding”.

In general, the injection moulding of RPT parts is carried out in an installation comprising an injection-moulding machine together with a mould. The injection-moulding machine comprises an assembly formed from a heated barrel and an injection screw, generally of the “single-screw” type, above which is a feed hopper for feeding with the thermoplastic and the glass strands.

The thermoplastic and the glass strands are introduced separately into the hopper, and then are mixed in the barrel/screw assembly, where the thermoplastic is melted and plasticized (that is to say converted into an injection-mouldable viscous material), and at the same time the glass strands are impregnated with the thermoplastic and dispersed therein.

The thermoplastic/glass compound obtained is then injected into the mould. The injection moulding takes place in three phases:
filling (or injection): the compound pushed by the injection screw acting as the ram fills the cavity of the mould. Where appropriate, pressure may be applied to the mould at the end of filling;
compacting: the compound is kept under pressure during the cooling step; and
cooling: the polymer solidifies and the RPT part is ejected when it is sufficiently rigid.

The aforementioned moulding technique does not permit the use of conventional chopped glass strands directly in the hopper—the strands intermingle and form entanglements that rapidly block the flow of the granulated thermoplastic and the glass strands towards the injection screw.

To provide suitable processing, the glass strands are consequently converted into granules.

Granules in which the glass strands of variable length are combined with a thermoplastic are known.

“Short” strand granules, with a length of less than 1 mm, are formed from a thermoplastic and chopped glass strands in an extruder equipped with a screw of the “twin-screw” type, and the extrudate formed is chopped into granules of the desired length. The high shear induced by this type of extrusion screw breaks up the glass filaments and consequently impregnates them sufficiently with the thermoplastic and disperses them correctly in the latter. However, the level of reinforcement is not very high owing to the short length of the glass strands.

“Long” glass strand granules, typically with a length of more than 6 mm, are obtained by making one or more continuous glass stands, for example in form of a roving, pass through a die fed with molten thermoplastic and then by chopping the cooled glass strand to the required length. This type of granule, also known as a pellet, contains glass strands with the same length as that of the granule—it gives the moulded parts better mechanical properties.

Other granules with a high glass content, of greater than 90% by weight, are known from WO 03/097543. However, these granules are not entirely satisfactory as the glass strands that they contain do not disperse correctly in the thermoplastic to be reinforced. The presence of clumps of strands within the matrix impairs the quality of the moulded parts, the mechanical performance of which is reduced.

The invention relates particularly to the latter type of granule with a high glass content.

The glass strands that make up these granules consist of a multitude of individual filaments (of the order of 1000 to 100 000 filaments per base strand), with a diameter of 5 to 24 μm, for example 10 μm to 17 μm, and a length generally not exceeding 30 mm.

In general, the glass filaments are coated with a size—it is important that the size, apart from protecting the filaments from abrasion during production of the strands, also imparts additional properties specific to the intended use.

The size must be able to bond the filaments together in order to give a strand that can be chopped into elements of identical length with the lowest possible quantity of “fines”, that is to say particles of smallest dimensions.

Because transport is usually carried out pneumatically, the size must also provide the glass-strand granules with the ability to withstand high mechanical stresses resulting from the strands rubbing against one another and against the walls of the transport lines, which rubbing causes the strands to open out and release the constituent glass filaments (a process called “filamentization”). The filaments then form what is called “fuzz” which obstructs the lines.

The size must also contribute to bonding the glass strands during granulation, in order to form high-density granules that can flow easily in the metering device and in the feed hopper of the injection screw. This is because most metering devices are weigh feeders based on a constant flow, which operate by opening hatches that release the granules, the open time being calculated and adjusted as the metering progresses. It is therefore important for the aspect ratio of the granule—defined by the length/diameter ratio—to remain constant, for the glass strands to remain sufficiently cohesive and for them not to be able to be released and entangled, forming “bridges” that disturb or even block the flow of materials towards the injection screw. The object of the present invention is to provide a sizing composition capable of coating glass strands in order to form chopped-strand granules, in particular those suitable for injection moulding, which have a high glass content and better dispersion in the thermoplastic matrix to be reinforced.

The sizing composition, forming the first subject of the invention is an aqueous composition comprising the following constituents, in the following contents by weight expressed as percentages of the solids:

10 to 99% of at least one copolymer chosen from ethylene/vinyl acetate or ethylene/(meth)acrylic acid copolymers;

1 to 40% of at least one coupling agent; and

0 to 90% of polypropylene grafted by at least one unit derived from at least one monomer containing one or more functional groups that can react with the coupling agent.

The copolymer allows the rate of impregnation of the strands with the thermoplastic to be varied. It results from the polymerization of ethylene with at least one monomer chosen from vinyl acetate, acrylic acid and methacrylic acid.

Advantageously, the copolymer has an ethylene content of at least 50%, preferably at least 65% and better still at least 80% by weight, thereby achieving good compatibility with the thermoplastic matrix to be reinforced.

The melting point of the copolymer is generally at least 30° C., preferably at least 50° C., below the melting point of the material to be reinforced. As a general rule, when the material to be reinforced is polypropylene, the copolymer possesses a melting point below 160° C., preferably below 140° C. and advantageously around 110° C.

The coupling agent allows the size to be attached to the surface of the glass filaments. The coupling agent is generally chosen from silanes, such as γ-glycidoxypropyltrimethoxysilane, γ-acryloxypropyltrinethoxysilane, le γ-methacryloxypropyltrimethoxysilane, γ-aminopropyltriethoxysilane, vinyltrimethoxysilane, phenylaminopropyltrimethoxysilane, styrylaminoethyl-aminopropyltrimethoxysilane or tert-butylcarbanoylpropyltrimethoxysilane, siloxanes, titanates, zirconates and mixtures of these compounds. Preferably, silanes, advantageously aminosilanes, are chosen.

The grafted polypropylene according to the invention comprises at least one side chain linked to the main polypropylene chain, the side chain being a unit derived from at least one monomer containing one or more functional groups that can react with the coupling agent. Preferably, the monomer is chosen from vinyl monomers and monomers carrying at least one of the following functional groups: alcohol, carboxylic acid, acid, especially carboxylic acid, anhydride, amide or epoxide.

The degree of grafting of the polypropylene (the ratio of the grafted monomer mass to the grafted polymer mass×100) is between 0.2 and 8%, preferably between 0.5 and 5%.

Advantageously, the polypropylene is grafted with maleic anhydride. As a general rule, the maleic anhydride content in the grafted polypropylene varies from 0.2 to 6%, preferably from 0.5 to 4%.

The melting point of the grafted polypropylene is generally above the melting point of the copolymer according to the invention described above.

The sizing composition obtained within the context of the invention may take the form of a solution, a suspension, a dispersion or an aqueous emulsion. Usually, the sizing composition is an emulsion.

Preferably, the sizing composition comprises the constituents below, in the following contents by weight expressed as percentages of the solids:

40 to 90% of at least one ethylene/vinyl acetate or ethylene/acrylic acid copolymer;

5 to 20% of at least one coupling agent, preferably a silane and advantageously an aminosilane; and

10 to 60% of grafted polypropylene, preferably maleic-anhydride-grafted polypropylene.

The sizing composition may further include one or more components hereafter called “additives”.

Thus, the composition may include at least one film-forming agent chosen from polyurethanes, expoxies, polyesters and polyvinyl acetates. The content of film-forming agent may range up to 40%, preferably up to 10%, by weight of the sizing composition.

The composition may also include, as additive, at least one surfactant or lubricant, which helps to protect the filaments from abrasion and contributes to limiting the formation of fuzz during fiberizing and chopping of the strand. The surfactant or lubricant is chosen from fatty-acid esters, such as decyl laurate, isopropyl palmitate, cetyl palmitate, isopropyl stearate, ethylene glycol adipate or trimethylolpropane trioctanoate, and alkoxylated, especially ethoxylated, derivates of these esters, derivatives of glycols, such as polyethylene glycols or polypropylene glycols, optionally containing alkoxy, especially ethoxy, groups, and mixtures of these compounds.

Again as additive, the sizing composition may include an antistatic agent such as a quaternary ammonium salt.

The sizing composition may also include, as additive, an anti-foaming agent, for example a polyalkylsiloxane, such as polydimethylsiloxane.

Preferably, the content of each of the aforementioned additives, with the exception of the film-forming agent, does not exceed 3% by weight of the composition, the total content of these additives remaining less than 5%.

The sizing composition generally has a solids content of between 2 and 20%, preferably 4 and 15% and advantageously around 10%.

The application of the sizing composition according to the invention to the glass filaments is carried out under the usual conditions known in the field. Streams of molten glass emanating from orifices provided at the base of one or more bushings are attenuated in the form of one or more sheets of continuous filaments, and then the filaments are assembled into one or more strands. The size is deposited on the strands or beneath the bushing, during attenuation.

The sized strands, which constitute another subject of the invention, are generally collected in the form of wound packages on rotating supports or are chopped before collection by a device that also serves to draw them, usually placed beneath the bushing. The strands obtained may thus be in various forms after collection, for example in the form of continuous strand packages (cakes, rovings comprising one or more base strands (assembled rovings), “cops”, etc.) or chopped strands.

The glass filaments constituting these strands have a diameter that may vary widely, usually from 5 to 30 μm, preferably 8 to 20 μm. They may consist of any glass, for example E-glass, C-glass, AR (alkali-resistant)-glass or glass with a reduced boron content (of less than 5%).

The base strands generally consist of 100 to 10 000, preferably 200 to 5 000, and advantageously around 1000 filaments.

In general, the quantity of size coating the glass strands does not exceed 2% by weight of the strand and is preferably between 0.2 and 1.8% and advantageously between 0.5 and 1.5%.

The size coating the glass strands has the particular feature that it softens at a lower temperature than the melting point of the material to be reinforced. Thus, under the moulding conditions, when the compound comprising the glass-strand/thermoplastic granules penetrates the single injection screw, the size starts to flow before the thermoplastic. This allows effective mixing of the materials and homogeneous distribution of the strands within the compound to be injection moulded.

In general, softening of the size takes place at a temperature a few degrees Celsius above the melting point of the component of the size that has the lowest melting point, and at least 10° C., preferably at least 20° C. and advantageously at least 50° C. below the melting point of the thermoplastic to be reinforced.

The sized glass strands, which constitute another subject of the invention, are used to form chopped-glass strand granules with a high glass content.

The granules may be obtained by any method known to those skilled in the art, for example that described in WO-A-96/40595, WO-A-98/43920, WO-A-01/05722 and WO-A-03/097543.

For example, the granules may be obtained using the method consisting in chopping the glass strands to a length of between 6 and 30 mm, preferably directly beneath the bushing, as indicated above, and subjecting them to a stirring operation in a suitable device so as to agglomerate them. In this way, the chopped strands are wet and generally contain 5 to 25% water by weight.

The chopped glass strands to which, where appropriate, water has been added so as to have a water content of between 10 and 25% by weight, are treated in a stirring apparatus for a time sufficient to obtain granules containing at least 50% by weight of glass. The granules are then dried in order to remove the water.

Advantageously, additives may be added during the stirring, in a proportion not exceeding 3% of the total weight of the compound.

The additives are chosen from coupling agents that couple to the matrix to be reinforced, for example maleic-anhydride-grafted polypropylene, anti-ageing agents for improving heat resistance or light resistance, and fillers, for example carbon black.

The dried granules consist of juxtaposed chopped strands and have a length approximately equal to that of the initial chopped glass strands, namely 6 to 30 mm, preferably 8 to 25 mm and advantageously 9 to 15 mm. The diameter of the granules is generally between 0.5 and 4 mm, preferably 1 and 3 mm.

The granules have a glass content that varies from 95% to 99.8%, preferably 98 to 99.5%, by weight.

The granules have a loss on ignition of less than 2%, preferably less than 1.8%, and advantageously varying from 0.5 to 1.5% by weight.

The granules may be used for reinforcing thermoplastics such as polyolefins, for example polyethylene and polypropylene, polyamides, polyalkylene terephthalates, for example polyethylene terephthalate (PET) and polybutylene terephthalate (PBT), styrene polymers, for example acrylonitrile-butadiene-styrene (ABS), polyphenylene sulphide (PPS), polycarbonates and polyacetals, for example polyoxymethylene (POM). Polypropylene is particularly preferred.

In general, the glass content in the final moulded part is between 10 and 60%, advantageously 20 and 30%.

Owing to their high glass content, the granules obtained from the glass strands coated with the composition according to the invention may be used in combination with any thermoplastic matrix. This is an advantage over the known granules for injection moulding, which contain a large amount (at least 30% and up to 80% by weight depending on the type of granule) of a thermoplastic which may have a certain incompatibility with the material to be reinforced. The following examples serve to illustrate the invention without however limiting it.

### EXAMPLES 1 TO 12

a) Preparation of the Sizing Composition

An aqueous sizing composition, comprising the compounds below, with the weight contents given in Table 1, in % of the solids, was prepared:
ethylene-vinyl acetate (EVA) copolymer: sold under the reference “EVA X®-28” by Michelman; ethylene weight content: 82%;
ethylene/acrylic acid (EAA) copolymer: sold under the reference “Michem® Prime 4983R” by Michelman; ethylene weight content: 80% ; weight-average molecular weight: 8400; acid number: 156; γ-aminopropyltriethoxysilane (silane): sold under the reference “Silquest® A-1100” by General Electric;
maleic-anhydride-grafted polypropylene (MAHgPP): sold under the reference “Michem® 43040” by Michelman; amount of grafting: 4% by weight; acid number: 45; weight-average molecular weight: 9100; and
polyurethane (PU): sold under the reference “Baybond® PU401” by Bayer.

The preparation of the sizing composition was carried out in the following manner:

The ethoxy groups of the silane⁽³⁾ were hydrolysed in demineralized water kept stirred, and then the other constituents were added, again with stirring. The final pH was around 10.

The weight content of solids in the sizing composition was 10%.

TABLE 1

| Example | EVA | EAA | silane | MAHgPP | PU |
|---|---|---|---|---|---|
| 1 | 50 | 0 | 10 | 40 | 0 |
| 2 | 80 | 0 | 10 | 10 | 0 |
| 2 | 40 | 0 | 10 | 40 | 10 |
| 4 | 45 | 0 | 10 | 25 | 20 |
| 5 | 60 | 0 | 10 | 20 | 10 |
| 6 | 90 | 0 | 10 | 0 | 0 |
| 7 | 65 | 0 | 10 | 25 | 0 |
| 8 | 20 | 0 | 10 | 70 | 0 |
| 9 | 70 | 0 | 10 | 20 | 0 |
| 10 | 0 | 70 | 10 | 20 | 0 |
| 11 | 0 | 50 | 10 | 40 | 0 |
| 12 | 0 | 0 | 10 | 70 | 20 |
| (comparative) | | | | | |
| 13 | 0 | 0 | 10 | 90 | 0 |
| (comparative) | | | | | |

b) Production of the Sized Strands

The sizing compositions were used for coating, in a known manner, E-glass filaments about 17 μm in diameter attenuated from glass streams emanating from the orifices of a bushing, these filaments being assembled into strands each consisting of 500 filaments.

### EXAMPLES 14 TO 26

The glass strands of Examples 1 to 13 were chopped to a mean length of 12 mm±1 mm and granulated in the granulator described in Patent Application WO 03/097543. The granules had a length of 12 mm±1 mm, a diameter of 2.5 mm, a relative density of 0.8 and a glass content of greater than 98%.

The granules obtained were analysed under the following conditions:
the quantity of fines, that is to say the quantity of free glass rods or filaments, was measured on a 500 g specimen of granules placed in a hopper, the outlet duct of which was located 4 mm from a vibrating channel allowing the granules to flow and spread homogeneously. The fines were collected in a trap located above the vibrating channel by means of a suction device. The quantity of fines, expressed in mg/kg, was measured on the granules before and after the transport test (see the next paragraph);
the quantity of fuzz after pneumatic transport of the granules (transport test) was measured as follows: 2 kg granules contained in a storage tank were sucked up through a critical circuit as far as the pneumatic injection hopper of a conventional injection-moulding machine. The filament fuzz formed was collected on the filter of the pneumatic hopper and weighed. The quantity of fuzz was expressed in mg/kg.
the granules were subjected to a PSI (“Pneumatic Stress Integrity”) test representative of pneumatic transport of the granules under high pressure and under severer stressing conditions than current industrial conditions. 50 g of granules were rotated in a stainless steel closed circuit under a pressure of 5 bar (0.5 MPa) for 45 seconds. The granules were recovered and screened in order to collect the fuzz. The percentage of fuzz as a function of the initial weight of granules was measured;
the loss on ignition, as a percentage, was measured under the conditions of the standard ISO 1887; and
the flow of the granules or fibres, expressed in seconds/kilogram, was measured as follows: the product (5 kg) was placed in a hopper, the discharge orifice of which was located 25.8 mm from a flow channel vibrating with an amplitude of 1 mm.

The characteristics of the granules are given in Table 2.

TABLE 2

| | | Fines before | Fines after | Transport | | Loss |
|---|---|---|---|---|---|---|
| | | pneumatic | pneumatic | test | | on |
| | Glass strand | transport | transport | (fuzz in | PSI Test | ignition |
| Example | (Ex.) | (mg/kg) | (mg/kg) | mg/kg) | (% fuzz) | (%) |
| 14 | 1 | 10 | 56 | 166 | <1 | 1.14 |
| 15 | 2 | 21 | 34 | 211 | <1 | 1.25 |
| 16 | 3 | 28 | 26 | 265 | <1 | 1.14 |
| 17 | 4 | 10 | 36 | 298 | <0.5 | 1.00 |
| 18 | 5 | 40 | 37 | 245 | <1 | 1.31 |
| 19 | 6 | 90 | 219 | 126 | <1 | 1.38 |
| 20 | 7 | 50 | 40 | 215 | <1 | 0.97 |
| 21 | 8 | 190 | 395 | 725 | <1 | 1.05 |
| 22 | 9 | 21 | 32 | 265 | <1 | 0.98 |
| 23 | 10 | 4 | 28 | 245 | <1 | 1.19 |
| 24 | 11 | 41 | 32 | 226 | <1 | 1.28 |
| 25 | 12 | 110 | 590 | 455 | >10 | 1.11 |
| (comparative) | | | | | | |
| 26 | 13 | 64 | 173 | 1052 | >30 | 1.09 |
| (comparative) | | | | | | |

The granules of Examples 14 to 26 had a flowability of less than 15 s/kg, compatible with usage in an injection-moulding machine.

The granules according to the invention have good mechanical strength properties during transport. The granules of Examples 14 to 20 and 22 to 24 in particular have a lower quantity of fines before and after pneumatic transport, and less fuzz under the conditions of the injection (Transport Test) and under severer conditions (PSI Test) than the granules of comparative Examples 25 and 26. The very low percentage fuzz obtained with the examples according to the invention, smaller by a factor of 10 and 30 in comparison with Examples 25 and 26 respectively, results in a high level of integrity of the glass strands due to the size. The granules of Example 21 have intermediate strength properties, in relation to the comparative examples, which remain acceptable for the intended application.

By way of comparison, it should be noted that glass strands coated with the size according to Example 13 that are chopped (length: 12 mm; loss on ignition: 0.75%) and not granulated (relative density: 0.4) could not be analysed under the test conditions mentioned—the strands rapidly entangled and formed “bridges” that blocked the flow in the transport circuit and/or hopper. These strands also had a poor abrasion resistance.

### EXAMPLES 27 TO 39

The granules of Examples 14 to 26 were used to manufacture composite parts by the technique of injection moulding. The granules, consisting of chopped glass strands and granulated thermoplastic (polypropylene), were transported pneumatically to a weigh feeder placed above an injection-moulding machine equipped with a single injection screw. The compound was injected into a mould for producing a plaque 2 mm in thickness. The amount of glass represented 30% of the total weight of the plaque.

The plaques were formed under the following conditions:

Condition 1: no pressure was applied to the injection screw, which operated at a speed of 130 revolutions per minute;

Condition 2: a pressure of 120 bar (12 MPa) was applied to the injection screw, which operated at a speed of 130 revolutions per minute, the speed being reduced to 80 revolutions per minute at the end of metering, thereby making it possible to slightly increase the material mixing time and to obtain better impregnation of the strands by the thermoplastic.

The plaques thus formed were placed over an illuminating device, making it possible to display any clumps of chopped strands not dispersed in the thermoplastic matrix. Image processing software (Mesurim) was used on the plaque in order to calculate the percentage area containing undispersed chopped-glass strands (% flaws).

The characteristics of the composite parts are given in Table 3.

TABLE 3

| | |
|---|---|
| Granules | % flaws |

| Example | (Ex.) | Condition 1 | Condition 2 |
|---|---|---|---|
| 27 | 14 | 7 | 1.5 |
| 28 | 15 | 5 | 1 |
| 29 | 16 | 9 | 2 |
| 30 | 17 | 8 | 2 |
| 31 | 18 | 6 | 1.5 |
| 32 | 19 | 5 | 1 |
| 33 | 20 | 7 | 1.5 |
| 34 | 21 | 11 | 4.5 |
| 35 | 22 | 5 | 1 |
| 36 | 23 | 7 | 1.5 |
| 37 | 24 | 6 | 2 |
| 38 (comparative) | 25 | 12 | 6 |
| 39 (comparative) | 26 | 14 | 8 |

Whatever the moulding conditions, the plaques obtained from the granules according to the invention exhibited better dispersion of the glass strands in the matrix and therefore a lower percentage of flaws than with the known granules (comparative Examples 38 and 39).

The moulding carried out under condition 2 gave a better dispersion without appreciably affecting the length of the fibres and therefore the level of performance in terms of reinforcement.

The mechanical properties of the plaques reinforced by the glass strands coated with the size according to the invention were comparable to those of Examples 38 and 39, especially the impact strength (Charpy and Izod tests) and the flexural strength.

1. A sizing composition for glass strands, comprising the following constituents, in the following contents by weight expressed as percentages of the solids:
10 to 99% of at least one copolymer selected from ethylene/vinyl acetate or ethylene/(meth)acrylic acid copolymers;
1 to 40% of at least one coupling agent; and
0 to 90% of polypropylene grafted by at least one unit derived from at least one monomer containing one or more functional groups that can react with the coupling agent.

2. The composition according to claim 1, wherein the copolymer has an ethylene content of at least 50%.

3. The composition according to claim 1, wherein the copolymer posseses a melting point below 160° C.

4. The composition according to claim 1, wherein the coupling agent is selected from silanes, such as γ-glycidoxypropyltrimethoxysilane, γ-acryloxypropyltrimethoxysilane, le γ-methacryloxypropyltrimethoxysilane, γ-aminopropyltriethoxysilane, vinyl-trimethoxysilane, phenylaminopropyltrimethoxysilane, styrylaminoethyl-aminopropyltrimethoxysilane or tert-butylcarbanoylpropyltrimethoxysilane, siloxanes, titanates, zirconates and mixtures thereof.

5. The composition according to claim 4, wherein the coupling agent is a silane.

6. The composition according to claim 1, wherein the grafted polypropylene contains at least one unit derived from at least one monomer selected from vinyl monomers and monomers carrying at least one of the following functional groups: alcohol, carboxylic acid, acid, anhydride, amide or epoxide.

7. The composition according to claim 6, wherein the grafted polypropylene has a degree of grafting of between 0.2 and 8%.

8. The composition according to claim 1, wherein the polypropylene has a melting point above the melting point of the copolymer.

9. The composition according to claim 1, comprising:
40 to 90% of at least one ethylene/vinyl acetate or ethylene/(meth)acrylic acid copolymer;
5 to 20% of at least one coupling agent; and
10 to 60% of grafted polypropylen.

10. The composition according to claim 9, wherein the grafted polypropylene has a degree of maleic-anhydride grafting varying from 0.2 to 6%.

11. The composition according to claim 1, wherein the composition further comprises at least one film-forming agent selected from polyurethanes, epoxies, polyesters and polyvinyl acetates.

12. The composition according to claim 11, wherein the content of the film-forming agent does not exceed 40%, by weight of the sizing composition.

13. The composition according to claim 1, wherein it has a solids content is between 2 and 20%.

14. A glass strand coated with a sizing composition according to claim 1.

15. The glass strand according to claim 14, wherein it consists of 100 to 10 000 filaments.

16. The glass strand according to claim 14, coated with a quantity of size not exceeding 2% of the weight of the strand.

17. A chopped-glass-strand granule, comprising glass strands according to claim 14.

18. The granule according to claim 17, comprising 95% to 99.8% glass by weight.

19. The granule according to claim 17, wherein the granular has a loss on ignition of less than 2% by weight.

20. The granule according to claim 17, wherein the granular has a length of 6 to 30 mm.

21. The granule according to claim 17, wherein the granular has a diameter of between 0.5 and 4 mm.

22-24. (canceled)

25. A method of manufacturing composite parts comprising injecting into a mould for producing a plaque a chopped glass strand of claim 17 and a thermoplastic.

26. The method of claim 25, wherein the thermoplastic is selected from polyolefins, polyamides, polyalkylene terephthalates, styrene polymers, polycarbonates and polyacetals.

27. The method of claim 26, wherein the thermoplastic is polypropylene.
